(19) United States
(12) Patent Application Publication
(10) Pub. No.: US 2021/0139099 A1
(43) Pub. Date: May 13, 2021

(54) 2 ski, Pedal and Power Bike

(71) Applicant: Simon Bassein, Los Angeles, CA (US)

(72) Inventor: Simon Bassein, Los Angeles, CA (US)

(21) Appl. No.: 16/677,437

(22) Filed: Nov. 7, 2019

(51) Int. Cl. B62K 13/00; B62K 11/00; B62B 13/04; B62B 19/04; B62K 25/04; B62B 17/06

(52) U.S. Cl. CPC B62K 13/00; B62K 11/00; B62B 13/046; B62K 2025/048; B62K 25/04; B62B 17/062; B62B 19/04

(57) ABSTRACT

This invention contains different designs of ski, snowboard, and wheel supports that attach to an existing bicycle frame. The ski and wheel supports are interchangeable. This allows easy transformation of a bicycle to a ski bike, snowboard bike, electric bike, or pedal bike. Rider simply attaches the desired ski/wheel supports, depending on the activity desired. The brake and gear controls are easily changed out by replacing the entire steering bar. It saves people the necessity of buying and storing three different types of bikes. The bikes are also light weight and easily transported on the bike rack or lift.

### SUMMARY OF THE INVENTION

With the invention of duel-suspension mountain bicycle, it is now possible to separate the rear wheel and pedal mechanism from the bike frame and steering bar. This permits attachment of different mechanisms to the same bike frame, allowing a bicycle to be used for different purposes. This invention contains different designs for ski and wheel supports that fit the same bicycle frame. These supports can be easily changed out, thus changing the use of a bicycle to a ski-bike, a snowboard bike, an electric bike, or different type of pedal bike.

I started my design with building a ski bike first. Then the design was modified to hold a snowboard, or wheels that can be motor or pedal driven. I began with removing front and rear wheels. Then I separated the bike frame with steering fork from the pedal and rear wheel assembly. The brakes, gears, and cables were removed with the existing steering bar, and a new steering bar installed instead. This provided the basic bike frame for our use.

Next I built a front and rear ski or wheel supports, and a pedal/footrest bracket that has a suspension spring. The front support is a square metal tube that is rigidly attached to the steering fork in the middle and top, and at the bottom it is pivotally attached to a front ski or wheel. The rear support is a beam that is made from 2 metal C-channels welded together with spacers, and pivotally attach to the rear ski or wheel at the bottom. It is also pivotally attached to the frame in the middle and to the pedal/footrest bracket with a compression spring at the top. The top of the rear support slides within the pedal/footrest bracket compressing the spring. This provides the rear suspension to my invention. The frame, rear support and pedal bracket are bolted together forming a strong extension of frame to rear ski or wheel.

This invention also shows how the ski-bike design can be adapted to make (1) a snowboard bike by widening the base of rear support to hold a snowboard, (2) electric bike by widening the base to hold a wheel, and attaching a battery, an electric motor with chain drive to the rear support, or (3) a different type of pedal bicycle by adapting the rear support to hold a wheel and welding rotating pedals with gear and chain to the pedal bracket.

### BRIEF DESCRIPTION OF THE DRAWINGS

For a more complete understanding of the present invention, the objects and advantages thereof, reference is made to the descriptions taken in connection with the accompanying drawings briefly described as follows:

FIG. 1a is the right side view of the complete ski-bike.

FIG. 1b is the plan view of the complete ski-bike.

FIG. 2a is the right side view of the front ski assembly.

FIG. 2b is the plan view of the front ski assembly.

FIG. 3a is the right side view of the rear ski assembly.

FIG. 3b is the plan view of the rear ski assembly.

FIG. 4a is the right side view of footrest bracket with rear suspension.

FIG. 4b is the plan view of footrest bracket with rear suspension.

FIG. 5a is the right side view of pedal bracket with rear suspension

FIG. 5b is the plan view of pedal bracket with rear suspension

FIG. 6a is the right side view of snowboard bike

FIG. 6b is the plan view of snowboard bike

FIG. 7a is the right side view of electric bicycle

FIG. 7b is the plan view of electric bicycle

FIG. 8a is the right side view of pedal bicycle with small wheels

FIG. 8b is the plan view of pedal bicycle with small wheels

FIG. 9a is the right side view of pedal bicycle with large wheels

FIG. 9b is the plan view of pedal bicycle with large wheels

### DETAILED DESCRIPTION OF THE INVENTION

The embodiments of the present invention and their advantages are better understood by referring to FIGS. 1a-9b.

In an embodiment of the invention, FIGS. 1a and 1b illustrates the present invention of ski bike. It consists of a duel-suspension bike frame (1) that has a seat and a steering bar with front fork. The wheels, pedals, and rear wheel mechanism are removed to lighten the weight. The front ski support (2) and rear ski support (3) are attached to the bicycle frame with bolts. The rear ski assembly (3) is designed such that the space under the bike seat is open, to make it easier to transport it on the lift. The ski-bikes ride next to the person on the lifts. The pedal/footrest bracket (4) connects the rear ski assembly (3) to the bicycle frame (1) through a compression spring (6), giving the bikes rear suspension. A second set of footrests (5) is also provided to accommodate standing position. There is even another footrest (5) on top of rear ski so that rider can use this ski-bike on level ground. They stand on it with one foot, while pushing with the other foot, similar to push scooter. This permits a person to ride the ski bike in a seated, standing, or pushing position

In an embodiment of the invention, FIGS. 2a and 2b illustrates the front ski support (2). It consists of a short front ski (7) “child ski or snow blade”, pivotally connected to front extension tube (9) at the bottom by a bracket (8). The front extension tube (9) is rigidly attached to the tips of steering fork by couplings and bolts (11) in the middle, and at the top it is attached to the interconnecting ring of the fork by another bolt (11). The additional equally spaced holes (12) along the tube permit the height adjustment of the front ski.

In an embodiment of the invention, FIGS. 3a and 3b illustrates the rear ski support (3). It consists of a longer rear ski (10), pivotally connected to the back of a rear ski support bar (3) by a bracket (8). The rear ski support (3) slides over the bottom of frame and is attached in the middle by two bolts. At the top it is supported by the pedal/footrest bracket (4) with a compression spring (6). It is made of two 2″ metal channels welded together with metal spacers for strength. A slider tube (15) is located in the front end of assembly (3) and is free to move between the channels of the pedal/footrest bracket (4). The slider tube (15) is welded to a coupling nut, and connects to the pedal/footrest bracket (4) through a compression spring (16) with a tension adjusting bolt. This provides the rear suspension to the bikes. The additional holes (12) in the middle of rear ski support (3) permit the rear ski length adjustment. A second set of footrests (5) are also provided in the middle of the rear ski support (3) for convenience when riding standing. An additional footrest (6) is provided at the rear ski connection for push riding the ski-bikes on level surface. A pin attachment of rear ski permits easy interchange of different length skis.

In an embodiment of the invention, FIGS. 4a and 4b illustrates the front footrest bracket with rear suspension. It consists of two 1″ metal channels (4) welded together at the bottom by a plate with a tube, which supports a compression spring (6) and front footrests (5). The hole in the center of plate is for a tension adjustment bolt that screws into the coupling that is welded to the slider tube (15) of the rear ski support (3). The slider tube (15) is free to move between the 1″ channels (4), providing rear suspension to the bike. The adjustment holes (12) at the top of 1″ channels connect it to the frame (1) by a through bolt, allowing the height adjustment for the bike.

In an embodiment of the invention, FIGS. 5a and 5b shows the front pedal bracket with rear suspension. It consists of two 1″ metal channels (4) welded together on the bottom by a plate and turning pedals with gear (23). The pedals transmit the turning force with chain to the rear wheel. The plate supports a compression spring (6) that is held together by a tension adjusting bolt and slider tube (15) of rear ski support (3). The slider tube (15) is free to move between the 1″ metal channels (4), providing the rear suspension to the bicycle. The additional holes (12) on the top of the bracket attach to the frame (1) with a through bolt and permit the height adjustment of the bike.

In an embodiment of the invention, FIGS. 6a-9b provide additional uses for invention. This includes but not limited to: (a) attaching snowboard instead of ski in the rear; (b) attaching small motor, batteries, and small wheels instead of skis, or (c) attaching turning pedals with chain and wheels instead of skis.

FIGS. 6a and 6b show a design for a snowboard bike. To mount a snowboard the base of the rear ski support (3) is widened to transmit the loads efficiently. This is done by welding a U-shaped bent tube (17) on the end of rear ski support. The two pivot brackets (8) on the sides of snowboard attach it to the rear ski support with bolts. The rest of design remains the same.

FIGS. 7a and 7b show a design for an electric bicycle. The U-shaped bent tube (17) is similarly used to transmit the loads to the wheels (19). The front and rear supports (2, 3) are modified to hold a small wheel and brakes. The rear support is additionally made to hold a motor (20) and batteries (21). The brake and motor controls are attached to the steering bar like in bicycles.

FIGS. 8a and 8b show another design for BMX or FAT WHEELS style pedal bike. Instead of the motor and batteries, two rotating pedals with chain gear (23) are welded to the bottom of pedal bracket (4) instead of footrests. The smaller wheels (19) are used because they are easier to turn, and wider wheels (19) keep bike from sinking into sand or snow. The chain (24) transmits the pedaling force to the rear wheel (19). The brakes and gears are attached to the wheel supports similar to existing bicycles similar to existing bicycles, with brake and gear controls remaining on the steering bar.

In the embodiment, the front and rear ski or wheel supports are preassembled and attach to the same bicycle frame, forming different types of vehicles. Included in the invention are the different vehicles that these attachments can form. These attachments and vehicles can be altered and manipulated in several ways, not limited to accommodating different frames, riders, and activities. A stiffener can also be added to enable the bicycle to hold heavier loads and to resist stronger impact forces.

The invention has been described herein using specific embodiments for the purposes of illustration only. It will be readily apparent to one of ordinary skill in the art, that the principles of the invention can be embodied in other ways. Therefore, the invention should not be regarded as being limited in scope to the specific embodiments disclosed herein, but instead as being fully commensurate in scope with the fallowing claims.

I claim:

1. A ski-bike and kit that attaches to the bicycle frame with a seat, steering bar and fork comprising of:
a. front ski assembly that rigidly attaches to the steering bar, consisting of:
i. short front ski with bracket;
ii. a front extension tube with the connection bolts; and
b. rear ski assembly that pivotally attaches to bottom of bicycle frame, consisting of:
i. longer rear ski with bracket;
ii. welded rear support beam with connection bolts;
iii. rear footrest pedals; and
c. front pedal/footrest bracket that provides rear suspension, consisting of:
i. two front footrests;
ii. two metal channels welded to the interconnecting plate;
iii. compression spring with a tension adjusting bolt and a slider tube; and

2. The design of claim 1 adapted for use as different vehicles including but limited to:
a. snowboard bike
b. electric bicycle
c. pedal bicycles
